(19) United States
(12) Patent Application Publication
(10) Pub. No.: US 2018/0295048 A1
(43) Pub. Date: Oct. 11, 2018

(54) SYSTEM AND METHOD FOR AUTOMATIC DATA MANAGEMENT

(71) Applicant: WIREDIQ, LLC, Sarasota, FL (US)

(72) Inventor: Joe Rhem, Sarasota, FL (US)

(21) Appl. No.: 15/949,831

(22) Filed: Apr. 10, 2018

Related U.S. Application Data
(60) Provisional application No. 62/483,654, filed on Apr. 10, 2017.

(51) Int. Cl. H04L 12/26; H04L 12/24

(52) U.S. Cl. CPC H04L 43/50; H04L 43/0829; H04L 41/5022; H04L 43/0852; H04L 41/0896

(57) ABSTRACT

A system for administrating data transmission traffic of different types across network conditions, include an administrator which has a user portal for prioritization data types such as voice, video and data. The administrator has testing circuitry for determining the latency rate and dropped packet rate of possible network connections. The system includes an appliance which includes a controller which directs a router to route the traffic based upon the latency rate, dropped packet rate, bandwidth and user selected priorities.

### CROSS-REFERENCE TO RELATED APPLICATIONS

This application takes priority from on U.S. provisional application Ser. No. 62/483,654 filed Apr. 10, 2017.

### FIELD OF THE INVENTION

The application relates to system for administration of traffic across network connections.

### BACKGROUND OF THE INVENTION

Currently, most businesses have more than one inexpensive broadband network connection available for use at any given location. The network connections carry traffic from a number of data applications, such as voice, video, and audio. These systems include routers to direct traffic over the network connections to various data centers such as computer terminals, video players, phone receivers and the internet of things. Multiple network connections provide additional reliability and capacity. However, these connections often become overloaded or inefficient. A delay in urgent data can result in loss sales. Poor voice quality caused by delay in voice traffic can harm relationships with customers and business associates. When any type of communication transmission is degraded, transmission may take greater time to complete as both parties require to repeat the transmission.

To compensate for this ineffective traffic prioritization, businesses purchase additional capacity or bandwidth to allow for more data, both urgent and non-urgent be transmitted concurrently. The cost for this additional network capacity is high and adds to the operating cost of the business. The business will typically have different types of data application transmission traffic such as voice, video and data. If the traffic exceeds capacity then some of the traffic will be delayed.

However current systems do not have the ability to prioritize traffic and dynamically and automatically adjust which of the available network connection will carry specific applications to dynamically chosen derivatives.

### SUMMARY OF THE INVENTION

An appliance for management of data transmission traffic across a plurality of networks includes a box connected to each of the plurality of networks, a router disposed within the box to direct traffic to each of the plurality of networks, a controller connected to the router, the controller adapts to make routing decisions for the data packets based on the type of application at least one conditioned factor of each of the plurality of networks in a user selected priority factor for each type of application.

### BRIEF DESCRIPTION OF THE DRAWINGS

FIG. 1 is a schematic view of a system for automatic data management in accordance with the invention.

FIG. 2 is a perspective view of an appliance for use in the system in accordance with the invention.

FIG. 3. Is a flow chart showing system analysis of available network paths.

FIG. 4 is a diagram showing the steps of the method of administration in accordance with the invention.

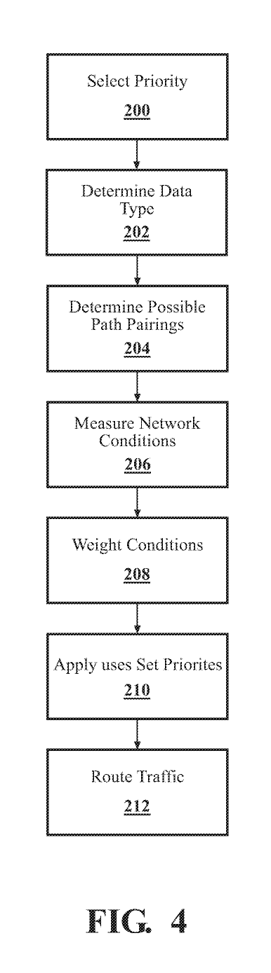

### DETAILED DESCRIPTION OF THE INVENTION

A novel system, appliance and method provide for dynamically and automatically optimizing data transmission traffic across multiple network connections. The system categorizes the type of data applications and routes traffic based on the type, user set priorities and network conditions. The system automatically routes data from different types of data applications between the network connections are between and a plurality of data centers. The types of data applications include voice, video, and data applications The network connections include both Wide Area Networks (“WAN”) and local area networks (“LAN”).

The system routes data across multiple network connections based on the data type, network conditions and user specific weights given to certain applications data such as voice or video, or data. The system routes the highest priority traffic on networks with the highest available capacity and routes lower priority traffic on networks with lower availability capacity. The system also evaluates all possible pairings of applications and available networks and assigns a score to each pairing possibility and then uses the score to choose which specific network. The system continuously makes route adjustments. The system provides the ability to bond system available networks together while dynamically and automatically adjusting which networks will carry which application data.

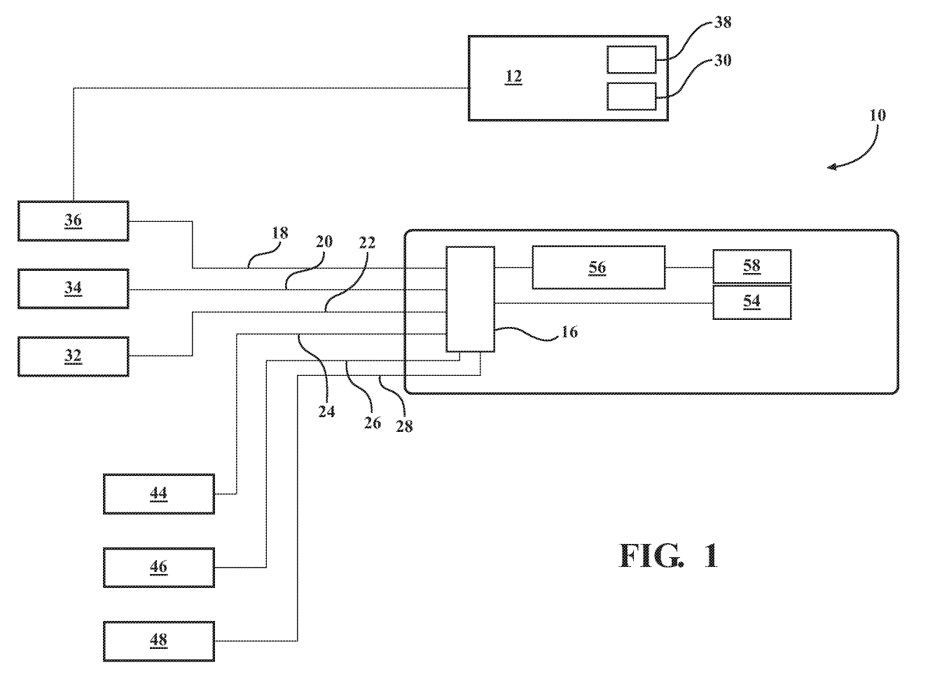

As shown in FIG. 1, the system 10 includes a system administrator 12, and an appliance 14 having a router 16 which makes continuous automatic and dynamic adjustments to the routing of data traffic of transmission across network connections 18, 20, 22, 24, 26 and 28.

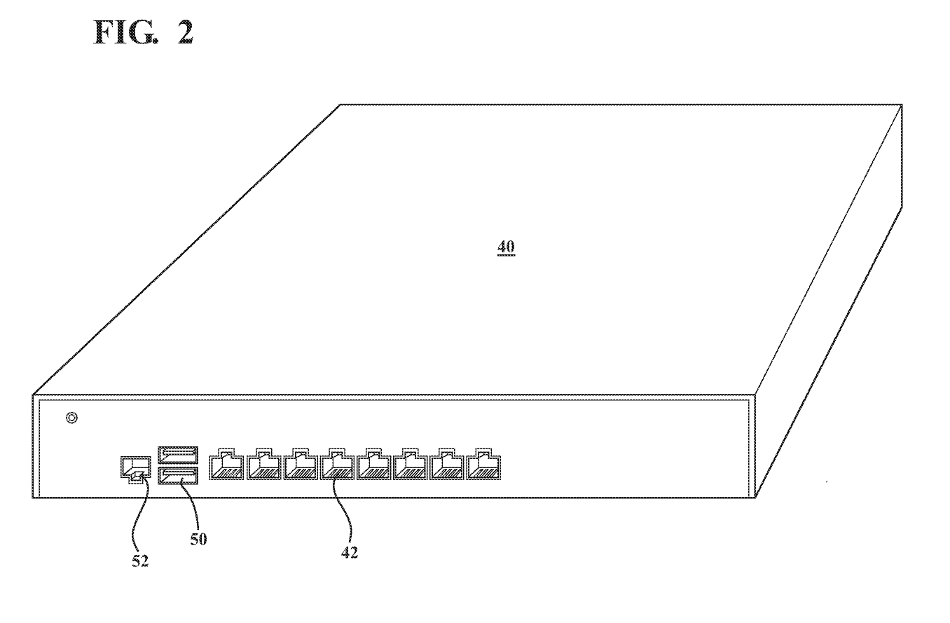

As shown in FIGS. 1 and 2, the appliance includes a box 40 which includes the router 16 such as an edge router which is connected to each of the data applications 32, 34 26 and data centers 44, 46, 48 through available network connections 18, 20, 22, 24, 26, and 28. Typically, the data applications such as voice 32, video 34, and data 36 are connected by CAT 5 or CAT 6 ethernet cables. The box 40 has ethernet ports 42 for a connection to cables connecting to various networks connections and applications. The box also includes USB ports 50 and phone connector 52. The appliance also has a Wi-Fi system 54 for connection to wireless LANs or data centers. The appliance 14 has a controller 56 uses the network conditions and user set priorities to route traffic having the highest priority on networks having highest available capacity. The appliance 14 also contains a buffer 58 for slowing down lower priority traffic when capacity is exceeded.

The system administrator 12 is remote from the appliance 12 and may be cloud based. The administrator 12 has a user portal 30 which permits the user to select priorities for transmission of data packets from data applications 32, 34, 36. Although this system 10 is shown connected to three data applications 32, 34, 36 any number of data applications can be connected to the system 10. The system administrator 12 is connected by internet to the appliance 14 through the data application 36.

The system administrator 12 determines the network conditions using testing circuitry 38 to send out known data packets on each of the available networks to the data centers 44, 46, 48. All of the possible pairings of a network connection and data centers for the data type are tested. The network conditions include “latency rate” or speed of delivery, the number of dropped packets and the bandwidth for each network connection.

The test packets are continuously set out at predetermined time intervals. The system receives information from the destination providing the receiving time, the number of dropped packets and whether the order of packets received is in the order sequence sent. A latency rate 62 or speed of delivery is calculated.

The user specifies through the user portal 30 of the system administrator 12, one or more data centers 44, 46, 48, for a particular application data type which are to be monitored. For example, a particular set of data centers 44, 46 are chosen for the users voice application 32 and a different set of data centers 44, 46 are chosen for the users video application 34.

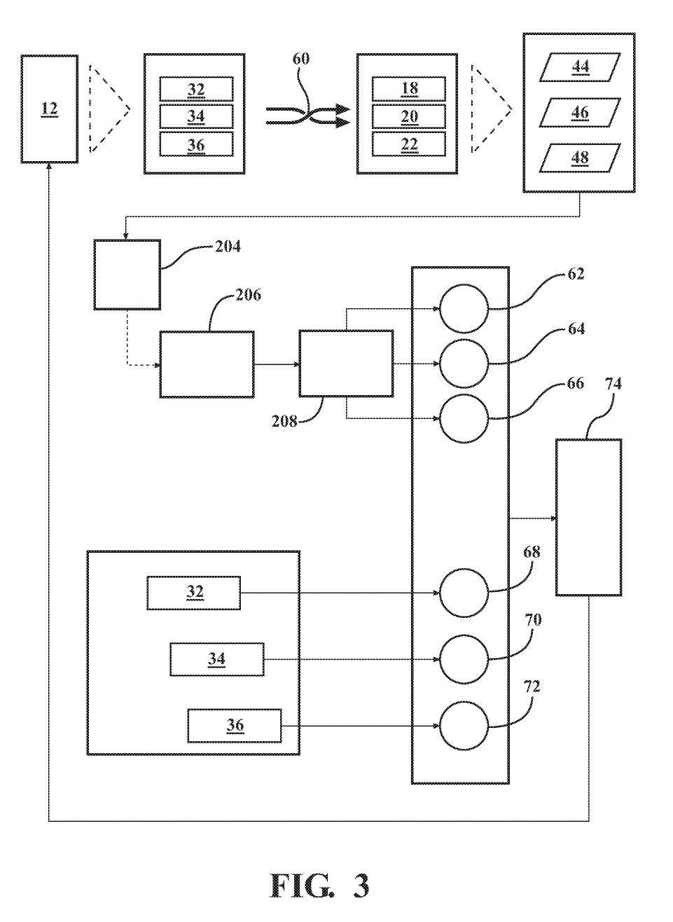

As shown in FIG. 3, the administrator 12 determines the elapsed time for each known data packet 60 to reach its destination from the testing circuit 08 by comparing the time the packet is sent with the time when a response is received from destination which is the “received time”.

The administrator then calculates a dropped packet factor for the dropped packets. The dropped packet factor is calculated by dividing the number of dropped packets by the total packets to determine the dropped packet rate. A weighted factor for each application data type, is applied to the measured latency rate 62 and the measured drop packets 64 rate determine the overall efficiency between each network connection and each destination specified for a particular type of application monitored. The weighted latency and dropped packet factors are further modified by the user by a priority index.

A priority index is specified by the user through the user portal 30. The user assigns a preference degree of prioritization for one application over the other. For example, an index of twenty is assigned for a video application 34 and an index of thirty for a voice application 32. This results in greater weight to be applied to the priority of voice application 32. The difference in between the indexes will shape the level of prioritization given to each applications transmissions. The greater the difference, the higher the weight given to the application with the higher index. In addition, the larger the index for an application, for instance thirty versus twenty the greater the weight given to the prioritization of the application.

The controller 56 receives the user set priorities and the weighted latency factor 62 and dropped packet factor 64 from the system administrator 12. The controller 56 determines the possible pairings 60 of network connections and data centers 44, 46, and 48 for the data type. The controller receives the bandwidth 66, type of data application and the destination address from the router 16. The controller 56 will then use network conditions, including the prioritized latency factor, dropped packet factor, and band width available together with the user set priorities to prioritize traffic.

The controller 56 controls the router 16 to select the proper network connections in accordance with data type, network conditions and user set priorities. The controller 56 receives user set priorities and network conditions from the system administrator. The controller 56 determines the possible pairings 60 of data applications and network connections for delivery of the data type to the desired data center such as data center 44.

The controller will treat the network path with most efficient combination of travel time and drop packets which has the network with the highest capacity and will treat the path with the least efficient combination of travel time and drop packets for particular application as the network with the lowest capacity.

The automated system and method provides ability to bond available networks together while also dynamically and automatically adjusting which available network will carry specified types of application data to dynamically choose a destination based on network conditions being monitored between the available networks and the specified destinations. This means that the system will use the total capacity from the combined bandwidth of available networks being bonded together without any systemic process that dynamically selecting which application data types will travel through the network.

The system administrator 12 continually analyzes the outcome of the routing decisions of the controller 56 and uses that analysis to continually adjust the determined network condition 74. Adjustments may include throttling the capacity through a network directing the data on an alternative path in crossing the transmission connection by directing data to the buffer 58. If a network is no longer available, the administrator 12 recalculates demand or capacity required in the capacity available. In these way, the traffic transmission to make best use of available resources. Initiating these actions may include automatic reactivation of backup networks.

As shown in FIGS. 3. and 4, the method 200 includes determining the type of data applications such as voice, video, and data 202, 204, 208 determining network conditions 206, determining possible paths pairings 204, weighting the conditions, applying user set priorities 210 and selecting a route 212 based on the priorities. The method also includes slowing down certain traffic when the system in at capacity and adding additional back up networks if available.

User set priorities are entered through the users portal of the system administrator 12. The priorities are stored in the controller 56 of the appliance 14. The controller 56 determines the data type such as voice, video and data using information from the router 16. The controller 56 determines the possible network connections for the data type to the desired data center. The testing circuitry 38 administrator 12 determines the network condition of latency rate, packet droppage rate by sending known data packets over all possible connections for the data type. The administrator 12 calculates weighted factors for latency and dropped packets and delivers the weighted factor to the controller 56. The controller 56 uses the latency factor, package droppage factor, bandwidth and user selected priorities to determine the route. The router may use the Wi-Fi for some network connections as an emergency system.

1. A system for management of data transmission traffic across a plurality of network connections, then system comprising:
a system administrator having a user portal for entry of user set priorities for each type of data application,
a testing circuit for determining network conditions,
an appliance having a controller and a router, the controller adapted to make routing pairings based on the user set priorities, and network conditions received from the system administrator and type.

2. The system of claim 1 wherein the network conditions include a latency rate, dropped packet rate and available bandwidth.

3. The system of claim 2 wherein the testing circuit is adapted to send out data packets of known size and type to calculate the latency rate and dropped packet rate using information from a receiving data center,

4. The system of claim 3, wherein the testing center tests all possible pairings of network connections and data centers for data type.

5. The system of claim 4, wherein the appliance has a database for storing user based priorities.

6. An Appliance for management of data transmission traffic across a plurality of networks between a plurality of data centers; the appliance comprising:
a box connected to each of the plurality networks;
a router disposed within the box, the router adapted to direct individual data packets based on the type of application,
at least one condition factor of each of the plurality of networks and a priority factor for each type of application.

7. The appliance of claim 6, further comprising a plurality of ethernet posts.

8. The appliance of claim 6, further comprising a buffer for storing data packets at times of high capacity.

9. The appliance of claim 6, wherein the controller is adapted to receive network condition factors from a remote administrator.

10. A method of management data transmission, the method comprising the steps of:
determining the application data type;
determining all possible paths for the data type to a desired destination;
determining network conditions of latency rate, dropped packet rate and bandwidth;
weighting the latency rate and dropped packet weight;
applying priorities for data type, and selecting a route.
